(19) United States
(12) Patent Application Publication
(10) Pub. No.: US 2023/0085070 A1
(43) Pub. Date: Mar. 16, 2023

(54) WOODEN PANEL COMPONENT, METHOD FOR PRODUCING A WOODEN PANEL AND USE OF A WOODEN PANEL COMPONENT

(71) Applicant: FRANK DOMSCHAT, Rheinfelden (DE)

(72) Inventor: Frank Domschat, Rheinfelden (DE)

(21) Appl. No.: 17/800,938

(22) PCT Filed: Feb. 22, 2021
(86) PCT No.: PCT/EP2021/054301

§ 371 Date: Aug. 19, 2022

(30) Foreign Application Priority Data
Feb. 25, 2020 (DE) 10 2020 104 929.3

(51) Int. Cl. E04C 2/34; E04C 2/10; E04C 2/38; E04C 2/296; B32B 3/12; B27D 1/06

(52) U.S. Cl. CPC E04C 2/34; E04C 2/10; E04C 2/38; E04C 2/296; B32B 3/12; B27D 1/06; E04C 2002/3488; B32B 5/02

(57) ABSTRACT

A wooden panel component (1) is provided having at least two layers (4) of cross-pieces (5) arranged within its frame (2). The cross-pieces (5) are orientated obliquely to opposing frame sides (6,7) of the frame (2) for bracing the wooden panel element (1) and the frame (2) thereof.

### TECHNICAL FIELD

The invention relates to a wooden panel component, to a method for producing a wooden panel component, and to the use of a wooden panel component.

### BACKGROUND

Wooden panel components are known in practice in various embodiments. They are used in wooden panel construction, for example as wooden panel construction walls for the construction of buildings such as prefabricated houses. The advantage of wooden panel components is that they can be prefabricated in a factory. For the construction of a building, the prefabricated wooden panel components are then brought to the construction site and installed in situ. Owing to the high degree of prefabrication, a building can be erected very quickly with the help of such wooden panel components.

Wooden panel components can be provided, if required, with wall openings, e.g. for windows and/or doors. In the design and production of the wooden panel components, however, it is necessary to know beforehand the position of the wall openings for any windows and/or doors in order to be able to provide the supports required for the stiffening of the wooden panel component within a frame of the wooden panel component according to the position of the cutouts. This is disadvantageous for fully automated manufacture of such wooden panel components. Although prefabrication of the wooden panel components is possible, the prefabrication of the wooden panel components must generally be carried out in compliance with the customer-specific requirements, e.g. with regard to possible wall openings for windows and/or doors.

### SUMMARY

It is therefore the object of the invention first of all to provide a wooden panel component and a method of the type stated at the outset which are favorable for prefabrication of wooden panel components in a manner which is as independent of specific orders as possible.

To achieve the object, a wooden panel component of the type stated at the outset is first of all proposed, said type having means and features of the independent claim, which is directed to a wooden panel component of this kind. To achieve the object, the proposal is, in particular, for a wooden panel component having a frame within which at least two or more layers of cross-pieces are arranged, wherein the cross-pieces are aligned obliquely to frame members of the frame. The frame members, to which the cross-pieces are aligned obliquely within the frame, can preferably be mutually opposite frame members of the frame.

The wooden panel component according to the invention can be used as a base element, into which wall openings of the desired shape and/or number can be made within the shortest possible time, in order to provide door and/or window cutouts, for example, to customer-specific requirements. The basic design of the wooden panel component, which is supported on the at least two layers of cross-pieces arranged within the frame, can dispense with support beams which have hitherto been conventionally used within the frame and whose positioning within the frame must be selected as a function of desired wall openings. The layers of cross-pieces form a uniform network of force supports within the frame, which allows a more uniform distribution of occurring forces within the frame than individual support beams of the kind which have hitherto been used in wooden panel construction. In this way, the wooden panel component according to the invention can first be prefabricated as a base element, independently of a specific customer order, and only then customized to customer-specific requirements and, in the process, provided with wall openings, for example.

The at least two cover layers of cross-pieces aligned obliquely within the frame give the wooden panel construction wall the required stability. The cross-pieces of the at least two layers can be provided in a density within the frame which allows sufficient stability of the wooden panel component. If individual cross-pieces or groups of cross-pieces are severed during the production of a wall opening, a sufficient number of cross-pieces which can be used as force supports is still available in the at least two layers of cross-pieces. Since the at least two layers of cross-pieces can form a largely or even completely uniform network of cross-pieces within the frame, wall openings can be introduced into the prefabricated wooden panel component at virtually any desired position without significantly impairing the stability of the wooden panel component.

Adjacent cross-pieces within one layer may be at a distance of, for example, 30.5 cm from one another. In this way, the at least two layers of cross-pieces within the frame of the wooden panel component have a sufficient strut density which allows reliable stabilization of the wooden panel component even if one or more wall openings for producing window or door cutouts are subsequently introduced into the wooden panel component.

In this way, the design of the wooden panel component according to the invention leads to the possibility of producing the wooden panel component as a prefabricated wooden panel component in a single step and with a high degree of standardization. In a subsequent step, the customer-specific work on the finished base element can be performed and, in the process, any wall openings that may be desired for window and/or door cutouts can be produced individually.

By separating the working steps, particularly economical production of the wooden panel components is possible. The wooden panel components can be produced in advance with a height of 2.5, 2.75 or 3.5 m and a length of 12 or 14 m, for example, and then shortened to the desired length, if required. Of course, it is possible to produce the wooden panel components in any practicable length and height. In a subsequent working step, the wooden panel components can be customized to customer-specific requirements and, for example, the wall openings mentioned can be made. By virtue of the design according to the invention, the wooden panel component can always have the same construction irrespective of the number and position of the wall openings in the wooden panel component. This has hitherto not been possible with the wooden panel components known from practical experience owing to their supporting beams, which as a rule run at right angles within the frames.

In a preferred embodiment of the wooden panel component, provision is made for the cross-pieces to be connected to the mutually opposite frame members. This can additionally increase the stability of the wooden panel component and its frame structure. The connection between the cross-pieces and the mutually opposite frame members can be effected in a positive and/or nonpositive and/or materially bonded manner, for example. In particular, it is possible to adhesively bond and/or glue the cross-pieces, in particular at their ends, to the frame members. It is furthermore possible to connect the cross-pieces to the frame members with the aid of clamps, nails, screws, toothed lock washers or hardwood nails.

The cross-pieces of the at least two layers of cross-pieces can be aligned within the frame at an acute or at an obtuse angle to at least one of the two frame members. The cross-pieces preferably span an angle deviating from a right angle with the frame members. The cross-pieces of the at least two layers of cross-pieces are preferably inclined at not more than 60° to one of the two frame members.

Particularly uniform force distribution force within the frame of the wooden panel component can result if the cross-pieces of two adjacent layers are inclined at equal but opposites. Furthermore, adjacent cross-pieces within one layer may be at a distance of between 10 cm and 70 cm, particularly preferably at a distance of 30.5 cm, from one another. The arrangement of cross-pieces within a layer of adjacent cross-pieces at a distance of 30.5 cm from one another has proven to be particularly advantageous since this arrangement represents a good compromise between the use of material, weight and load-bearing capacity of the wooden panel component.

It may be advantageous if the at least two layers of cross-pieces within the frame are arranged offset relative to one another in a depth direction aligned transversely to the longitudinal extent of the frame members of the frame. In one embodiment of the wooden panel component, the layers of cross-pieces can be arranged offset relative to one another along a total frame depth, which can be measured transversely to the longitudinal extent of the frame members. Here, a total thickness of the layers of cross-pieces, which can be measured in the depth direction, can be as large as a depth of the frame. The two or more layers can thus be arranged in different planes, in particular planes parallel to a longitudinal direction of extent of the frame members, within the frame. In this way, the at least two layers of cross-pieces arranged within the frame form a network which stiffens the frame of the wooden panel component. This is particularly the case when the cross-pieces of adjacent layers intersect and/or are inclined in different directions.

For additional stiffening of the wooden panel component, cross-pieces of adjacent layers can be connected to one another. This can be effected in a positive, nonpositive and/or materially bonded manner, for example. A suitable materially bonded connection between cross-pieces of adjacent layers of cross-pieces is, for example, an adhesively bonded and/or glued joint between the cross-pieces. A positive and/or nonpositive connection between cross-pieces of adjacent layers can be achieved, for example, by means of nails, screws, clamps, toothed lock washers and/or hardwood nails. If the cross-pieces of adjacent layers are intersecting cross-pieces, it may be expedient to connect the cross-pieces to one another at their respective intersection points.

The two frame members can each have a grid of retention points for each layer of cross-pieces. In this case, the grids of retention points for the individual layers on the respective frame member can be arranged offset relative to one another. The grids of retention points can have a pitch of between 10 and 70 cm, in particular 30.5 cm. In this connection, pitch can mean that the retention points of the respective grid are at a distance of from 10 cm to 70 cm, in particular at a distance of 30.5 cm, from one another. The retention points of the grids can be arranged in retaining depressions. The retaining depressions can be designed, for example, as retaining grooves, on/in which the cross-pieces are fastened by their ends to the frame members in accordance with the respective grid at retention points.

In a preferred embodiment of the wooden panel component, the retaining grooves can be introduced transversely to the longitudinal extent of the two frame members in inner sides of the frame members facing the interior space of the frame.

The cross-pieces can be connected in a positive and/or nonpositive and/or materially bonded manner to the frame members of the frame at their retention points. The types of connections already mentioned above can be used as positive, nonpositive and/or materially bonded connections, for example.

A distance between two adjacent retaining depressions, in particular between two adjacent retaining grooves, in at least one frame member can correspond to half the distance between two adjacent retention points of a, for example of the aforementioned, grid of retention points of a layer of cross-pieces and/or to half the distance between two adjacent cross-pieces within a layer of cross-pieces. As a result of the density of retaining depressions thus achieved, it is possible to obtain a sufficiently high density of braces if these are arranged in at least two, preferably mutually offset, layers between the frame members.

The frame of the wooden panel component can have a paneling element on at least one side, preferably on both sides. The paneling element can consist of boards, which are formed, for example, from OSB material, plasterboard, concrete, clay, gypsum, natural gypsum, wood fibers, cement-bound building boards. A wooden formwork can also serve as a paneling element. The at least one paneling element can be fastened to the frame members of the frame and/or to the cross-pieces of at least one layer of cross-pieces. In this context, it may be advantageous if at least one layer of cross-pieces is arranged within the frame so as to end flush with an outer side of the frame members. The at least one paneling element of the wooden panel component can be fastened in a positive, nonpositive and/or materially bonded manner, for example. Positive, nonpositive and/or materially bonded connections have already been mentioned above. The aforementioned types of connection can also be used to fasten the paneling element to the frame and/or the cross-pieces.

Interspaces within the frame can be filled with a filler, in particular with insulating material. In this way, the wooden panel component can be equipped, for example, with sound insulation and/or thermal insulation. In one embodiment of the wooden panel component, provision is made for the aforementioned interspaces to be filled with insulating material boards in layers and/or with bound and/or unbound packing.

The frame and/or the cross-pieces of the at least two layers of cross-pieces can preferably be made of wood and/or of a wooden material.

The wooden panel component described above is suitable for use as an inner wall, outer wall and/or facing wall in and/or on a building. The wooden panel component can also be used particularly advantageously for renovation, refurbishment and/or energy-efficient refurbishment of existing buildings.

In the case of energy-efficient refurbishment of a building, the wooden panel component equipped with thermal insulation can be attached, for example, as a facing wall to a facade of the building to be refurbished. The wooden panel component can be provided beforehand with a hole pattern of wall openings which corresponds to a hole pattern of window openings present in the facade.

The wooden panel component may also be used as a facade element of a curtain wall or of a modular facade.

To achieve the object, a method for producing a wooden panel component, in particular a wooden panel component as claimed in any of the claims directed to such, is also proposed, which comprises the method steps of the independent claim directed to such a method. According to the invention, the method comprises at least the following steps:

providing two mutually opposite frame members of a frame of the wooden panel component, introducing a first layer of cross-pieces between the two frame members, wherein the cross-pieces are aligned obliquely to the two frame members,

fastening cross-pieces of the first layer to the two oppositely arranged frame members of the frame,

introducing at least one further layer of cross-pieces between the two frame members, wherein the cross-pieces are aligned obliquely to the frame members,

fastening cross-pieces of the at least one further layer to the two frame members.

Preferably, all the cross-pieces of the first and of the at least one further layer are fastened to the two frame members of the frame.

The cross-pieces of the first layer and the cross-pieces of each further layer of cross-pieces can be fastened in a positive, nonpositive and/or materially bonded manner in the way already explained above.

The two mutually opposite frame members, between which the layers of cross-pieces are introduced, are preferably longitudinal members of the frame of the wooden panel component to be produced.

In a preferred embodiment of the method, which permits the production of wooden panel components from an endless strand, as it were, it is envisaged that a plurality of frame members is first connected to form two mutually opposite, spaced-apart strands of frame members. This has the aim of producing a segment strand of interconnected segments of wooden panel components, from which individual segments of any desired length can be cut. In this context, an unfinished wooden panel component can be interpreted to be a segment.

Provision is preferably made here for at least two frame members per strand to be connected to one another, in particular to be finger jointed. In this way, two mutually opposite strands are produced from a plurality of frame members, between which the at least two layers of cross-pieces can then be introduced. In this way, it is possible initially to produce strands of frame members of any desired length connected to cross-pieces, which strands, as will be explained in more detail further below, are subsequently shortened to the desired length in order to produce individual wooden panel components.

In one embodiment of the method, provision is made for retaining depressions, in particular the aforementioned retaining grooves, to be introduced, for example milled, into the frame members. This is preferably done before the first of the at least two layers of cross-pieces is introduced between the two frame members arranged opposite one another at a distance from one another.

In one embodiment of the method for producing a wooden panel component, the following steps are provided:

providing a frame,

introducing a first layer of cross-pieces into the frame, wherein the cross-pieces are aligned obliquely to two mutually opposite frame members of the frame,

fastening cross-pieces of the first layer to the two oppositely arranged frame members of the frame

introducing at least one further layer of cross-pieces into the frame, wherein the cross-pieces are aligned obliquely to two mutually opposite frame members of the frame

subsequently fastening the cross-pieces of the at least one further layer to the two oppositely arranged frame members of the frame.

In this embodiment, a frame is thus provided and then filled and stiffened with at least two layers of cross-pieces.

In order to impart an even greater stability to the wooden panel component, cross-pieces of adjacent layers of cross-pieces can be connected to one another. In this case, the connection can preferably be effected at intersection points of the cross-pieces and/or in a positive and/or nonpositive and/or materially bonded manner.

In this context, it may be advantageous if the at least two layers of cross-pieces are introduced into the frame in such a way that cross-pieces of the at least two layers intersect.

Interspaces within the frame can be filled with a filler, e.g. with insulating material. This can be carried out in layers, for example with insulating material boards or, if appropriate, also with bound and/or unbound packing.

The filler can preferably be introduced in layers, and in this case particularly preferably together with the layers of cross-pieces.

If the filler is introduced in the form of layers or mats between the frame members and into the interspaces between the cross-pieces, it may be expedient to introduce the cross-pieces and layers of filler one after the other until a layer of cross-pieces with filler filled into the interspaces between the cross-pieces has been completed.

In a preferred embodiment of the method, the frame members can be arranged on a first paneling element and connected to the paneling element. In this case, the frame members are preferably arranged as strands of interconnected frame members on a first paneling element and are preferably connected to the paneling element. This is preferably done before the at least two layers of cross-pieces are introduced between the frame members.

Furthermore, the frame members, in particular after the introduction of the layers of cross-pieces and/or of the previously mentioned filler, can be covered with and, in particular, connected to a second paneling element. The second paneling element can be arranged on a side of the frame members which faces away from the side of the frame members with the first paneling element already mentioned above.

To cut a segment to length to produce a wooden panel component, the frame members, in particular the strands of frame members, can be severed transversely to their longitudinal direction of extent. This is preferably done after the introduction of the at least two layers of cross-pieces between the two frame members and, if appropriate, also after the introduction of filler into the interspaces between the cross-pieces of the at least two layers of cross-pieces. The segment can be cut from a segment strand of still interconnected segments of wooden panel components.

In this way, a segment of the desired length for the production of a wooden panel component can be severed from a segment strand of still connected, semi-finished wooden panel components and made available for final processing.

Subsequently, the separated segment of a wooden panel component can be finished in order to produce the frame of the wooden panel component by attaching two further frame members, which can then be referred to as transverse members. For this purpose, a filling consisting of cross-pieces and/or filler can be removed, in particular milled off, at a separating cut of the segment in accordance with a thickness of a frame member, in particular a transverse member, which is to be attached.

The frame members already mentioned above, in particular the transverse members of the frame, can then be connected to the frame members to form a closed frame. It is furthermore possible to place a second paneling element on the frame only when the frame has been closed by the connection of the transverse members to the frame members.

In one embodiment of the method, the frame is first deposited on a paneling element, preferably before the introduction of the at least two layers of cross-pieces. The paneling element, for its part, can be positioned on a production support and connected in a materially bonded, positive and/or nonpositive manner to the frame members of the existing frame. If nails, screws and/or clamps or toothed lock washers or hardwood nails are used to fasten the paneling element to the frame members, it is possible to introduce the nails, screws, clamps, toothed lock washers and/or hardwood nails into the frame members from below through the paneling element.

In this way, it is possible to carry out the paneling of the frame of the wooden panel component without having to rotate the frame and the paneling element to fasten the paneling element to the frame. This promotes the manufacture of particularly large-format wooden panel components.

The at least one paneling element of the frame can be placed on a production support before the frame members or the frame are/is positioned on the paneling element. If the frame is not deposited on a paneling element before the layers of cross-pieces are introduced, the frame can also be deposited directly on a production support.

A transport means, such as a conveyor belt, a roller conveyor and/or a transport trolley, can be used as the production support on which the frame members, the finished frame and/or a paneling element of the wooden panel component can be deposited, before, for example, the at least two layers of cross-pieces are introduced.

In the variant of the method in which a finished frame of a wooden panel element is equipped with layers of cross-pieces, it is possible, in particular after the introduction of the layers of cross-pieces and/or after the optional introduction of filler, for the frame also to be covered with and/or, in the process, closed off by means of a second paneling element. In this way, a closed wooden panel component is created which has a paneling element on both sides.

In a subsequent method step, provision can be made for at least one wall opening, for a window and/or a door for example, to be introduced into the wooden panel component, in particular after a paneling element has been applied on both sides. The wall opening can be sawn into the wooden panel component.

In a further embodiment of the method, the at least one wall opening can subsequently be equipped with a component. It is possible, for example, to use windows, roller shutters and/or doors as conceivable components.

In a preferred embodiment of the method, provision is made for at least one robot to be used to carry out at least individual steps of the aforementioned method steps. In this way, the preferably fully automated production of such wooden panel components is possible.

### BRIEF DESCRIPTION OF THE DRAWINGS

The invention is now described in greater detail by means of an illustrative embodiment, but it is not restricted to this illustrative embodiment. Further illustrative embodiments can be obtained by combining the features of one or more claims and/or in a combination of one or more features of the illustrative embodiment. In the, in part, highly schematized illustration:

FIG. 1 shows a partially broken-away, isometric representation of a wooden panel component implementing the invention, having a frame, and a total of four layers of cross-pieces, which are arranged offset relative to one another within the frame and are aligned obliquely between mutually opposite frame members of the frame,

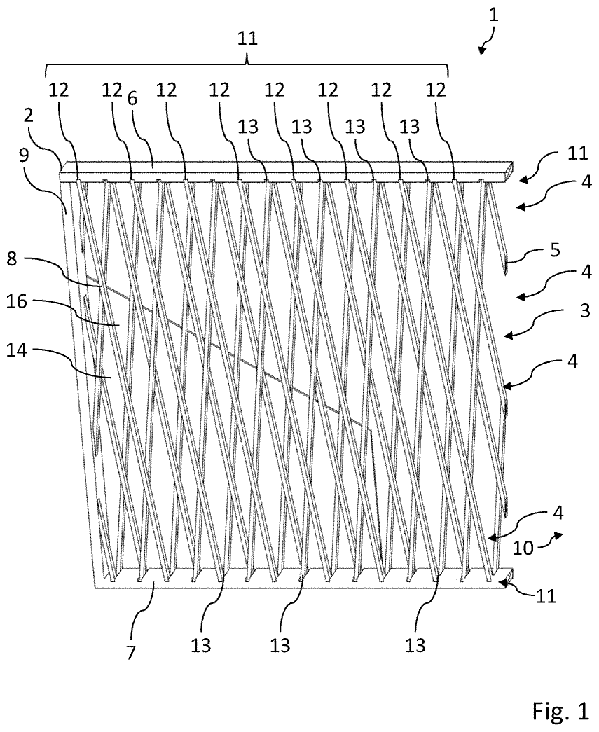

FIG. 2 shows a partially broken-away side view of the wooden panel component illustrated in FIG. 1,

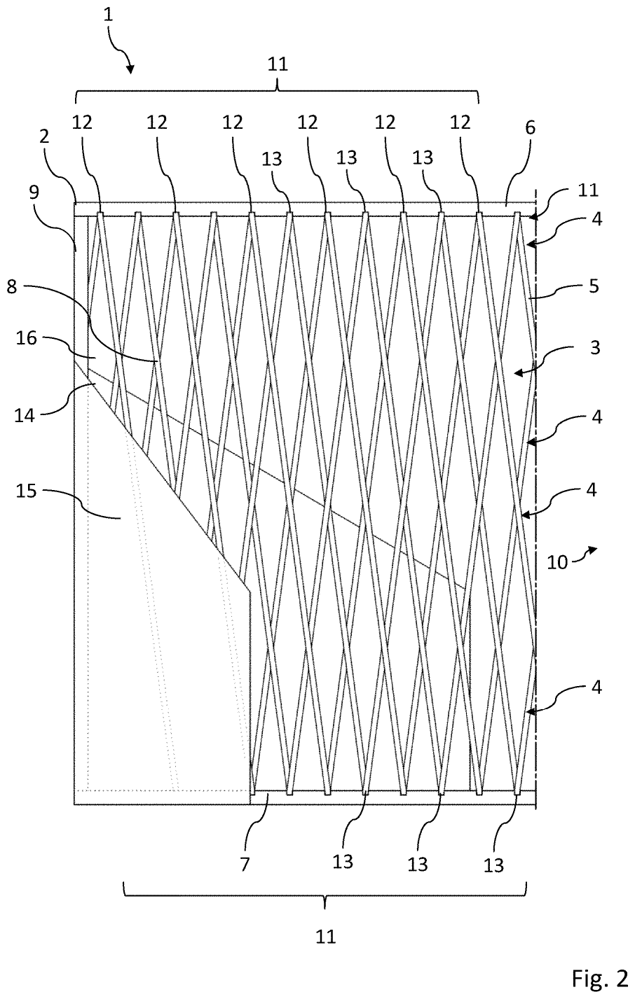

FIG. 3 shows a side view of the frame of the wooden panel component illustrated in FIGS. 1 and 2,

FIG. 4 shows a sectional view of the frame along the line A-A indicated in FIG. 3 to illustrate a grid of retention points at which the cross-pieces of the four layers are fastened to the frame members of the frame of the wooden panel component,

FIG. 5 shows a side view of the wooden panel component illustrated in the previous figures with two wall openings for a door and a window, and

FIGS. 6 to 10 show perspective illustrations to illustrate the method steps for producing a wooden panel component of the kind illustrated at least in part in FIGS. 1 to 5.

### DETAILED DESCRIPTION

All the figures show at least parts of a wooden panel component designated as a whole by 1 in the form of a wooden panel construction wall. The wooden panel component 1 comprises a frame 2, which is composed of a total of four frame members 6 and 7, as well as 9 and 10, arranged opposite one another in pairs.

In an interior space 3 defined by the frame 2, that is to say within the frame 2, at least two layers and, in the exemplary embodiment of the wooden panel component 1 which is shown, a total of four layers 4 of cross-pieces 5 are arranged, which are aligned obliquely to two mutually opposite frame members 6 and 7 of the frame 2. Frame member 6 is a horizontally extending frame member which is at the top in the position of use of the illustrated wooden panel component 1. Frame member 7 of the frame 2 of the wooden panel component 1 is a lower frame member which extends horizontally in the position of use of the wooden panel component 1.

The cross-pieces 5 of the total of four layers 4 are connected to the two opposite frame members 6 and 7. The cross-pieces 5 can be connected to the two frame members 6 and 7 in a positive, nonpositive and/or materially bonded manner. A possible positive and/or nonpositive connection is, for example, a connection using nails, screws, pins, clamps, toothed lock washers and/or hardwood nails. A materially bonded connection of the cross-pieces 5 to the mutually opposite frame members 6 and 7 can be effected, for example, by adhesively bonding and/or gluing the cross-pieces 5 to the frame members 6 and 7.

The cross-pieces 5 each enclose an angle with the two frame members 6 and 7 which deviates from a right angle, that is to say is, for example, an acute or an obtuse angle. The acute angles which can be measured between the cross-pieces 5 and the frame members 6 and 7 are no more than 60°.

The construction of the wooden panel component 1 provides for the cross-pieces 5 of two adjacent layers 4 to be inclined at equal but opposites. This has the effect that cross-pieces 5 of the two adjacent layers 4 intersect in pairs at an intersection point 8. In the case of the wooden panel component 1 shown in the figures, cross-pieces 5 arranged adjacent to one another within a layer 4 of cross-pieces 5 are at a distance of 30.5 cm from one another.

The total of four layers 4 of cross-pieces 5 are arranged in different planes, parallel to a longitudinal extent of the two frame members 6 and 7, which are connected to one another by the cross-pieces 5, within the frame 2 and distributed over the entire depth of the frame 2.

The two opposite frame members 6 and 7 to which the cross-pieces 5 of the four layers 4 are connected are longitudinal members of the frame 2 of the wooden panel component 1. In this arrangement, frame members 6 and 7 are longer than the two other frame members 9 and 10 of the frame 2, which are aligned at right angles to frame members 6 and 7. The frame 2 thus has a rectangular shape. The two frame members 9 and 10 may also be referred to as transverse members 9 and 10 of the frame 2.

The figures make it clear that some of the cross-pieces 5 of the layers 4 within the frame 2 are arranged between one of the two horizontally aligned frame members 6 and 7 and one of the two shorter frame members 9 and 10 aligned perpendicular thereto, and are each connected thereto. This promotes additional stiffening of the frame 2 and the wooden panel component 1 equipped with it.

As has already been mentioned above, cross-pieces 5 of adjacent layers 4 intersect since the cross-pieces 5 of adjacent layers 4 are inclined in different directions. If required, intersecting cross-pieces 5 of adjacent layers 4 can be connected to one another at their respective intersection point 8. As already mentioned above, this can be effected in a positive, nonpositive and/or materially bonded manner.

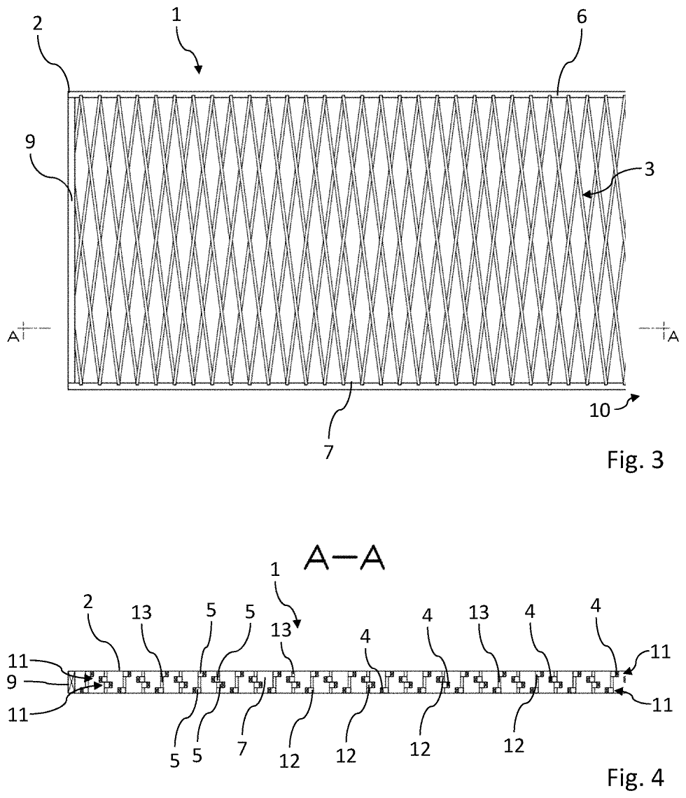

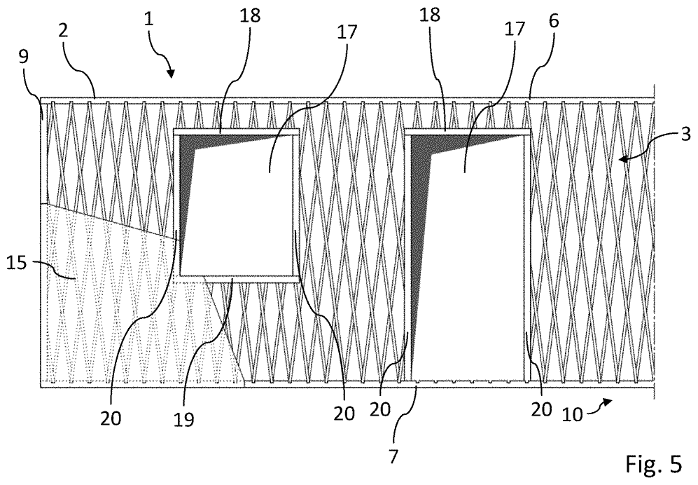

FIG. 4, which shows a sectional view of the frame 2 of the wooden panel component 1 according to section line A-A indicated in FIG. 3, makes it clear that each layer 4 of cross-pieces 5 is connected to the frame members 6 and 7 in accordance with a grid 11 of retention points 12. Thus, each of the two frame members 6 and 7 has one such grid 11 of retention points 12 for fastening cross-pieces 5 of the individual layers 4 to the frame members 6 and 7. The retention points 12 of the individual layers 4 are provided in retaining depressions in the form of retaining grooves 13. The retaining grooves 13 are introduced transversely to the longitudinal extent of the two frame members 6 and 7 into the inner sides of the frame members 6 and 7 facing the interior space 3 of the frame 2.

The ends of the cross-pieces 5 project into the retaining grooves 13 at retention points 12 in order to fasten them to the frame members 6 and 7 in accordance with the grid 11 provided for them. The retention points 12 of the individual layers 4 are arranged offset relative to one another on the two frame members 6 and 7. The retention points 12 for fastening the cross-pieces 5 to the frame members 6 and 7 are thus distributed over the retaining grooves 13 introduced into the frame members 6 and 7. FIG. 4 shows that the cross-pieces 5 of the two inner layers 4 of cross-pieces are fixed in every second retaining groove 13. The retention points 12 of the cross-pieces 5 of the two outer layers 4 of cross-pieces 5 are arranged in the remaining retaining grooves 13.

Each grid 11 of retention points 12 has a pitch of 30.5 cm. This means that two adjacent retention points 12 of a grid 11 of a layer 4 of cross-pieces 5 are at a distance of 30.5 cm from one another. As a result, pairs of retaining grooves 13 in which the retention points 12 of the different grids 11 of the total of four layers 4 of cross-pieces 5 are arranged are at a distance from one another which corresponds to half the distance between two adjacent cross-pieces 5 of a layer 4 and to half the distance between two adjacent retention points 12 of a grid 11 and thus to a distance of 15.25 cm.

The wooden panel component 1 comprises two paneling elements 14 and 15, each of which is arranged on one side of the frame 2. Each of the two paneling elements 14 and 15 is fastened, on the one hand, to the frame members 6, 7, 9 and 10 of the frame 2 and, on the other hand, also to at least some of the cross-pieces 5 of at least one layer 4 of cross-pieces 5.

Interspaces 16 which may be present within the frame 2 of the wooden panel component 1, even after the layers 4 of cross-pieces 5 have been introduced, are filled, if required, with a filler 23, for example with insulating material. The frame 2 and the cross-pieces 5 of the wooden panel component 1 shown in the figures consist of wood or of a wooden material.

Boards made, for example, of concrete, gypsum, natural gypsum, clay, wood and/or wood fibers can be used for the paneling elements 14 and 15 on both sides of the wooden panel component 1. The use of OSB boards for the paneling elements 14 and 15 of the wooden panel component 1 is preferred.

The wooden panel component 1 described above can be produced by the method described below. Provision is accordingly made for a frame 2 of the wooden panel component 1 to be prepared first. This can be done on a production support not shown in the figures. A first layer 4 of cross-pieces 5 is then introduced into the frame 2. In this process, the cross-pieces 5 are aligned obliquely to two mutually opposite frame members 6 and 7 of the frame 2.

The cross-pieces 5 of the first layer 4 of cross-pieces 5 which has been introduced into the frame 2 are then fastened to the two oppositely arranged frame members 6 and 7 of the frame 2. The abovementioned retaining grooves 13 can be introduced immediately beforehand into the frame members 6 and 7. Alternatively, it is also possible to use frame members 6 and 7 into which the retaining grooves 13 have already been introduced at an earlier point in time.

In a further method step, at least one further layer 4 of cross-pieces 5 is introduced into the frame 2. In this process too, the cross-pieces 5 are aligned obliquely to the two mutually opposite frame members 6 and 7 of the frame 2. The cross-pieces 5 of the at least one further layer 4 of cross-pieces are then fastened to the two oppositely arranged frame members 6 and 7 of the frame 2.

If required, cross-pieces 5 of adjacent layers 4 of cross-pieces 5 can be connected to one another. The cross-pieces 5 can preferably be connected to one another at their intersection points 8. Interspaces 16 within the frame 2 can be filled with a filler 23, in particular with an insulating material 23. During this process, it is possible to introduce the filler in layers, for example in the form of insulating boards, or else as bound or unbound packing material.

In one embodiment of the method, provision is made for the frame 2 to be deposited on a paneling element 14 of the wooden panel component 1, which is to be produced in accordance with the method, in particular before a first layer 4 of cross-pieces 5 is introduced. The frame 2 can then be connected to the paneling element 14. The layers 4 of cross-pieces 5 can then be introduced into the frame 2. As soon as the frame 2 has been stiffened with the cross-pieces 5 of the different layers 4 and any interspaces 19 that may be present within the frame 2 have been filled with filler 23, a second paneling element 15 can be applied to that side of the frame 2 which is remote from the first paneling element 14 in order to close the frame 2 and thus the wooden panel component 1.

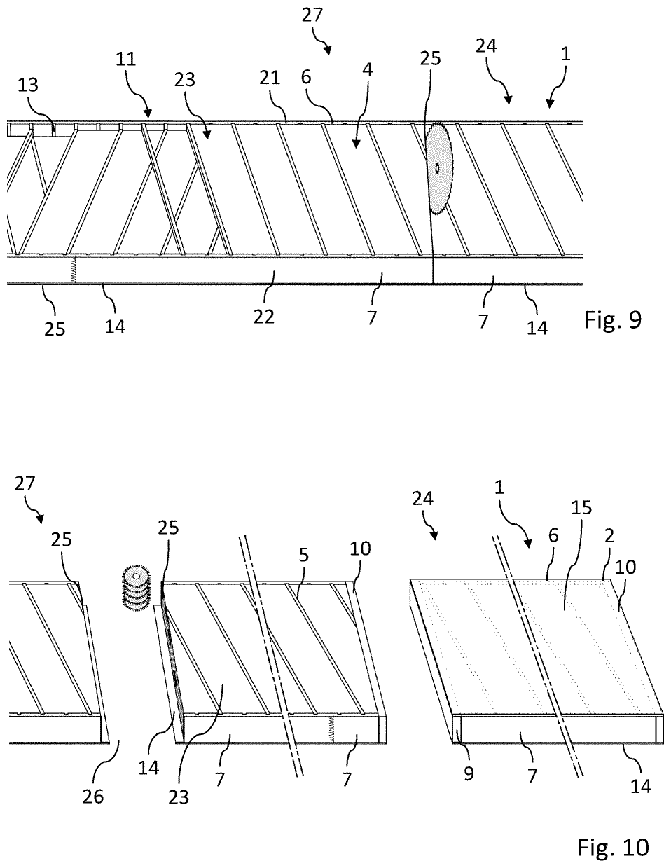

A preferred method for the production of the wooden panel component 1 can be explained with reference to FIGS. 6 to 10.

FIG. 6 shows continuous production of wooden panel components 1 from a continuous strand. During this process, a segment strand 27 of semifinished, still connected segments 24 of wooden panel components 1 is produced, and the segments 24 for the wooden panel components 1 to be produced are cut to the desired length from the segment strand 27. FIGS. 7 to 10 show enlarged detail sections of the overall illustration of FIG. 6.

In order to produce a wooden panel component 1, provision is made for at least two mutually opposite frame members 6 and 7 of a frame 2 of a wooden panel component 1 which is still to be closed to be provided first. Here, longitudinal members of a rectangular frame 2 of the wooden panel component 1 to be produced are preferably provided as frame members 6 and 7.

A first layer 4 of cross-pieces 5 is then introduced between the two frame members 6 and 7, wherein the cross-pieces 5 are aligned obliquely to the frame members 6 and 7. Cross-pieces 5 of the first layer 4 are then fastened to the two oppositely arranged frame members 6 and 7 of the frame 2.

In a subsequent method step, at least one further layer 4 of cross-pieces 5 is introduced between the two frame members 6 and 7, wherein the cross-pieces 5 are aligned transversely to the frame members 6 and 7. These cross-pieces 5 of the at least one further layer 4 are also fastened to the two frame members 6 and 7. All the aforementioned types of fastening can be used to fasten the cross-pieces 5 to the frame members 6 and 7.

The method steps explained above can be repeated until the intended number of layers 4 of cross-pieces 5 has been introduced between the two frame members 6 and 7 of the wooden panel component to be produced.

In the exemplary embodiment shown in FIGS. 6 to 10, a total of four layers 4 of cross-pieces 5 is introduced between the two frame members 6 and 7. In this case too, cross-pieces 5 of adjacent layers 4 of cross-pieces 5 can be connected to one another, if required. The cross-pieces 5 can preferably be connected to one another at their intersection points 8.

One special feature of the method illustrated in the figures provides that a plurality of frame members 6 and 7 are connected to one another to form two mutually opposite strands 21 and 22 of frame members 6 and 7. With the aid of the strands 21 and 22 of frame members 6 and 7, which are composed of a plurality of individual frame members 6 and 7, it is possible to produce wooden panel components 1 of virtually any desired length. For each strand 21 and 22, at least two frame members 6 and 7 are finger jointed to one another, as can be seen, in particular, from FIG. 7.

Before the layers 4 of cross-pieces 5 are introduced between the frame members 6 and 7, retaining depressions for the cross-pieces 5 in the form of retaining grooves 13 are milled into the frame members 6 and 7 in accordance with FIG. 7.

Interspaces 16 between the cross-pieces 5 of the individual layers 4 are then filled with filler 23. As indicated in FIG. 8, this can preferably take place in layers.

FIG. 8 illustrates that the cross-pieces 5 are introduced in layers, alternating with filler 23, between the frame members 6 and 7.

The frame members 6 and 7 connected to form strands 21 and 22 are arranged on a first paneling element 14 and connected to the paneling element 14. As the paneling element 14, a plurality of boards are guided in a butt-jointed manner on the production support, here on a transport means 26, for example on a conveyor belt or a roller conveyor.

As indicated in FIG. 8, the strands 21 and 22 of frame members 6 and 7 are arranged on the boards of the paneling element 14 before the layers 4 of cross-pieces 5 are introduced between the frame members 6 and 7.

It can be clearly seen that the layers 4 of cross-pieces 5 and the filler 23 between the strands 21 and 22 of frame members 6 and 7 are applied to or over the paneling element 14 in a way which spans the boards.

After the layers 4 and the filler 23 have been introduced in layers between the two strands 21 and 22 of frame members 6 and 7, the second paneling element 15 is applied in a subsequent method step and is connected at least to the frame members 6 and 7 and, if appropriate, also to the frame members 9 and 10 and/or the cross-pieces 5 of the outermost layer 4 of cross-pieces 5.

In the method illustrated in FIGS. 6 to 10, the application of the second paneling element 15 is provided as the last method step after a segment 24 for a single wooden panel component 1 has been separated from a segment strand 27 of still interconnected segments 24 of wooden panel components 1.

The production of the wooden panel components 1 takes place on a production support 26, which is only indicated in FIGS. 6 to 10. A transport means 26, which can be, for example, a conveyor belt, a roller conveyor and/or a transport trolley, serves as the production support.

To cut a segment 24 for a wooden panel component 1 to length, the strands 21 and 22 of frame members 6 and 7 are severed, after the introduction of the filling consisting of filler 23 and the layers 4 of cross-pieces 5, transversely to their longitudinal direction of extent. This method step is illustrated in FIG. 9.

In order to prepare the separated segment 24 for the subsequent production step, the filling consisting of cross-pieces 5 and filler 23 is removed at the separating cuts 25 of the segment 24 in accordance with a thickness of a transverse member 9, 10, which is connected to the frame members 6 and 7 in order to close the frame 2. In the exemplary embodiment shown according to FIG. 10, the filling is milled off, it being apparent that the lower paneling element 14 of the wooden panel component 1 is not cut back further during this process.

Further frame members 9 and 10, namely the already mentioned transverse members 9 and 10 of the frame 2, are then connected to the frame members 6 and 7 to form the closed frame 2. After this, as already mentioned above, the second paneling element 15 is placed on the frame members 6 and 7 and also the frame members introduced as transverse members 9 and 10 and is connected thereto (see right-hand half of FIG. 10 with the finished wooden panel component 1).

After the frame 2 has been provided with the paneling elements 14 and 15 on both sides, it is possible in all the abovementioned method variants for at least one wall opening 17, for example for a window and/or a door, to be introduced into the wooden panel component 1, for example by sawing. If required, the wall opening 17 can be fitted with a door frame or a window frame and/or with a functional element, for example with a door and/or a window and/or a roller shutter.

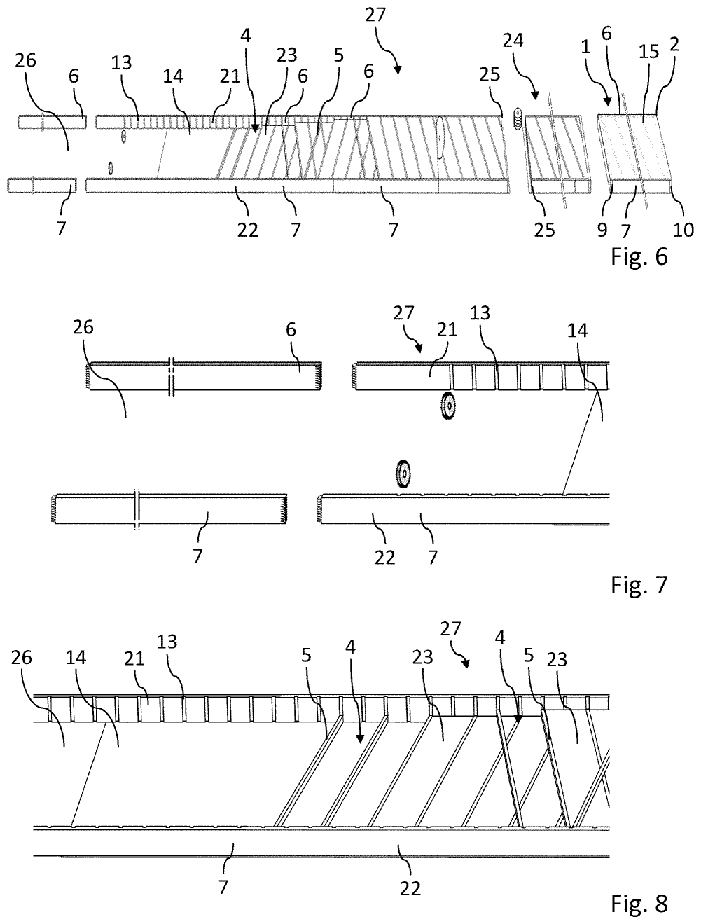

FIG. 5 shows an example of a wooden panel component 1 in the form of a wooden panel construction wall. The wooden panel component 1 from FIG. 5 has two wall openings 17. The wall opening 17 on the left in FIG. 5 is provided for a window and is bounded by a lintel member 18, a parapet member 19 and two jamb members 20. The right-hand one of the two wall openings 17 serves as a door opening and is bounded at the top by a lintel member 18 and laterally by two jamb members 20. The lintel members 18, the jamb members 20 and the parapet members 19 are made of wood and can therefore also be referred to as wooden lintel beams, wooden jamb beams or wooden parapet beams.

In a preferred embodiment of the above-described methods, individual or all the method steps are carried out by means of at least one robot.

The abovementioned wooden panel component 1 is suitable for use as an inner wall, outer wall and/or facing wall of a building, but also as a roof element, ceiling element and/or floor element of a building. The use of the wooden panel component 1 as a facing wall is particularly favorable for renovating existing buildings in a particularly efficient manner, in particular for renovating them for energy efficiency.

The invention relates, inter alia, to a wooden panel component 1 which has at least two layers 4 of cross-pieces 5 arranged within its frame 2. To stiffen the wooden panel component 1 and its frame 2, the cross-pieces 5 are aligned obliquely to mutually opposite frame members 6 and 7 of the frame 2.

### LIST OF REFERENCE SIGNS

1 wooden panel component
2 frame
3 interior space of 2
4 layer of cross-pieces
5 cross-pieces
6 upper frame member
7 lower frame member
8 intersection point
9 frame member, transverse member
10 frame member, transverse member
11 grid
12 retention points
13 retaining grooves
14 paneling element
15 paneling element
16 interspace
17 wall opening
18 lintel member
19 parapet member
20 jamb member
21 strand of 6
22 strand of 7
23 filler
24 segment
25 separating cut
26 production support/means of transport
27 segment strand

1. A wooden panel component (1), comprising:
a frame (2) including at least two frame members (6, 7); and
at least two layers (4) of cross-pieces (5) arranged within the frame (2) that are aligned obliquely relative to the frame members (6, 7) of the frame (2).

2. The wooden panel component (1) as claimed in claim 1, wherein cross-pieces (5) of the at least two layers (4) are connected to mutually opposite ones of the frame members (6, 7).

3. The wooden panel component (1) as claimed in claim 2, wherein the cross-pieces (5) are aligned at an acute or an obtuse angle to one of the at least two frame members such that the cross-pieces (5) span an angle deviating from a right angle with the at least two frame members (6, 7).

4. The wooden panel component (1) as claimed in claim 1, wherein at least one of: the cross-pieces (5) of two adjacent ones of the layers (4) are inclined at equal but opposite angles or adjacent ones of the cross-pieces (5) within one of the layers (4) are at a distance of between 10 cm and 70 cm from one another.

5. The wooden panel component (1) as claimed in claim 1, wherein the at least two layers (4) are arranged in mutually offset planes within the frame (2).

6. The wooden panel component (1) as claimed in claim 2, wherein the two opposite frame members (6, 7), to which the cross-pieces (5) are connected, are longitudinal members of the wooden panel component (1) and are longer than adjacent ones of the frame members that define transverse members (9, 10) of the frame (2).

7. The wooden panel component (1) as claimed in claim 1, wherein at least one of: the cross-pieces (5) of adjacent ones of the layers (4) intersect or the cross-pieces (5) of adjacent ones of the layers (4) are inclined in different directions.

8. The wooden panel component (1) as claimed in claim 1, wherein the cross-pieces (5) of adjacent ones of the layers (4) are connected to one another at intersection points (8).

9. The wooden panel component (1) as claimed in claim 1, wherein the at least two frame members (6, 7) each have, for each said layer (4) of the cross-pieces (5), a grid (11) of retention points (12), to which the cross-pieces (5) are fastened by ends thereof, the grids (11) of retention points (12) are arranged offset from one another on respective ones of the frame members (6, 7).

10. The wooden panel component (1) as claimed in claim 1, wherein the frame (2) has a paneling element (14, 15) on at least one side, the paneling element (14, 15) is fastened to at least one of the frame members (6, 7), adjacent frame members (9, 10), or the cross-pieces (5) of at least one said layer (4).

11. The wooden panel component (1) as claimed in claim 1, further comprising interspaces (16) within the frame (2) that are filled with a filler (23).

12. The wooden panel component (1) as claimed in claim 1, wherein the wooden panel component comprises at least one of an inner wall, an outer wall, a facing wall, a roof element, a ceiling element, a floor element or a facade element of a curtain wall or of a modular facade.

13. A method for producing a wooden panel component (1), comprising following steps:
providing two mutually opposite frame members (6, 7) of a frame (2) of the wooden panel component (1),
introducing a first layer (4) of cross-pieces (5) between the two mutually opposite frame members (6, 7), wherein the cross-pieces (5) are aligned obliquely to the two frame members (6, 7),
fastening the cross-pieces (5) of the first layer (4) to the two mutually opposite frame members (6, 7) of the frame (2),
introducing at least one further layer (4) of the cross-pieces (5) between the two mutually opposite frame members (6, 7), wherein the cross-pieces (5) are aligned obliquely to the two mutually opposite frame members (6, 7), and
fastening the cross-pieces (5) of the at least one further layer (4) to the two mutually opposite frame members (6, 7).

14. The method as claimed in claim 1, wherein a plurality of the frame members (6, 7) are connected to form two mutually opposite, spaced-apart strands (21, 22) of the frame members (6, 7), in order to produce a segment strand (27) of interconnected segments (24) of wooden panel components (1).

15. The method as claimed in claim 13, further comprising introducing retaining depressions into the frame members (6, 7).

16. The method as claimed in claim 13, wherein the cross-pieces (5) of adjacent ones of the layers (4) of cross-pieces (5) are connected to one another at intersection points (8).

17. The method as claimed in claim 13, further comprising filling interspaces (16) between at least one of the cross-pieces (5) or the frame members (6, 7) with a filler (23).

18. The method as claimed in claim 13, further comprising arranging the two mutually opposite frame members (6, 7) on a first paneling element (14, 15) before the at least two layers (4) of the cross-pieces (5) are introduced between the two mutually opposite frame members (6, 7), and covering the frame members (6, 7) with a second paneling element (15) after the introduction of the layers (4) of the cross-pieces (5).

19. The method as claimed in claim 18, further comprising initially depositing at least one of the two mutually opposite frame members (6, 7) or the first paneling element (14, 15) on a production support.

20. The method as claimed in claim 13, further comprising severing the frame members (6, 7) transversely to a longitudinal direction of extent thereof, and, during this process, a segment (24) for the wooden panel component (1) is cut off.

21. The method as claimed in claim 20, further comprising removing a filling consisting of at least one of said cross-pieces (5) or filler (23) at a separating cut (25) of the segment (24) in accordance with a thickness of a transverse member (9, 10).

22. The method as claimed in claim 21, further comprising connecting transverse members (9, 10) to the frame members (6, 7) to form a closed frame (2).

23. The method as claimed in claim 18, further comprising introducing at least one wall opening (17), for at least one of a window or a door into the wooden panel component (1) after the first and second paneling elements (14, 15) have been applied on both sides.

24. The method as claimed in claim 13, further comprising using at least one robot to carry out at least individual ones of the method steps.

25. The method as claimed in claim 19, wherein the production support comprises at least one of a conveyor belt, a roller conveyor or a transport trolley.
